(19) United States
(12) Patent Application Publication
(10) Pub. No.: US 2005/0140167 A1
(43) Pub. Date: Jun. 30, 2005

(54) Vehicle interior trim panel component assembly and in-mold method of manufacturing same

(76) Inventor: Gurjeet K. Jaggi, Portage, MI (US)

Correspondence Address: LEAR CORPORATION, BLISS MCGLYNN, P.C., 2075 WEST BIG BEAVER ROAD, SUITE 600, TROY, MI, 48084, US

(21) Appl. No.: 10/749,157

(22) Filed: Dec. 30, 2003

(51) Int. Cl. B60J 5/04

(52) U.S. Cl. 296/146.7

(57) ABSTRACT

The present invention relates to a method of manufacturing an interior trim panel assembly having integrated trim panel components. The method of manufacture includes providing a die including a pair of die halves cooperating to define a mold cavity to form a interior trim panel where at least one of said die halves includes a surface defining an A-surface and the mold cavity includes a plurality of recesses. The method further includes placing a trim panel component into a recess and closing the die halves to form a rigid substrate within the mold cavity by injecting a molten thermoplastic material into the mold cavity mold cavity. The method further includes bonding the molten thermoplastic material to a trim panel component within the mold cavity while the rigid substrate is formed.

### BACKGROUND OF THE INVENTION

1. Field of the Invention

The present invention relates, generally, to molded trim panels for automotive vehicle interiors. More specifically, the present invention relates to a vehicle interior trim panel assembly having a plurality of components and in-mold method of manufacturing same.

2. Description of the Related Art

Automotive interiors commonly include several trim panels that are used to cover the mechanics of the vehicle from the vehicle interior, thereby creating an aesthetically pleasing vehicle interior. Trim panels found in a vehicle interior include door trim panels, dashboard trim panels, instrument cluster trim panels, glove box trim panels and door pillar trim panels, among others. Each of these trim panels provide an aesthetic surface to create a visually pleasing vehicle interior. A door trim panel, in particular, conceals the internal mechanics within a door panel, such as a window motor, sound dampening material and electrical wiring. Like all trim panels, a door trim panel includes a side visible from the vehicle interior. This side is commonly referred to as the “A-side.” The side of the trim panel located opposite the A-side is commonly referred to as the “B-side.” The B-side is not visible from the vehicle interior when the door trim panel is mounted to the vehicle door.

In addition, door trim panels typically include functional components such as a map pocket, bolster, pull handle, door latch handle, door lock control, side mirror controls, window controls, and speaker grill, among other components. These components are manufactured separate from the door trim panel, per se, and later assembled to the panel. The components to the door trim panel are generally mounted using sonic welding methods or the use of a heat-stacking machine, but may be accomplished though several other known methods such as riveting or screwing. In any event, the door trim panel per se and the assembled components must undergo additional handling and assembly to produce a complete door trim panel. The additional handling and assembly generates an increase in the tools, machines and labor necessary to fully assemble a complete door trim panel. This correlates into increased cost associated with the door trim panel assembly process.

Attempts have been made to reduce handling and assembly of the door trim panel and its components to streamline production and lower costs of a complete door trim panel. For example, U.S. Pat. No. 5,397,409 issued to Kornylo on Mar. 14, 1995, discloses a method for molding a vehicle door panel by placing a heated sheet of laminate material into a first mold component to vacuum form the upper section of the A-side of a door panel, including an integrated bolster area. The lower section of the A-side and the entire B-side of the door trim panel are then formed by a foamable material applied to the remaining mold components. The method disclosed in the '409 patent utilizes a complex mold having a vacuum component and a non-vacuum component within the same mold half Further, the method disclosed in the '409 patent manufactures a door panel having a plurality of B-side layers along the upper section which may give rise to assembly issues resulting from panel thickness when mounting the door trim pane to a vehicle door or when installing remaining door trim panel components.

U.S. Pat. No. 5,571,355 issued to Kornylo on Nov. 5, 1996 discloses a method of making a door panel with an integrated bolster. The method disclosed in the '355 patent includes forming a door trim panel substrate in a first mold and placing a heated sheet of vinyl into a second mold having two vacuum sources to form the A-side of a door trim panel including an integrated bolster. The door trim panel substrate is then placed in the second mold and bonded to the vacuum formed A-side to form a door trim panel. The method disclosed in the '355 patent pre-forms the substrate and the A-side coverstock in separate molds which may create fitting issues and/or require an additional step in assembly to trim excess material. Further, the method disclosed in the '355 patent requires additional assembly steps to mount other door panel components prior to assembling the door panel onto a vehicle door.

U.S. Pat. No. 5,868,455 issued to Springer et al. on Feb. 9, 1999 discloses a vehicle door panel having an integrated handle and method of manufacturing same. The method disclosed in the '455 patent includes providing a contoured substrate including an elongated reinforcement, placing a flexible cover material over the A-side of the contoured substrate and RF welding the flexible cover material along the elongated reinforcement to provide the A-side of the door trim panel with an integrated handle. The vehicle door panel disclosed in the '455 patent may include a one-piece or a two piece a rigid substrate. In either event, the rigid substrate includes two stands and an elongated reinforcement disposed therebetween. A single sheet of flexible material is employed to cover the rigid substrate, thus defining the A-side of the door trim panel. Use of a two-piece rigid substrate where each piece is pre-formed may give rise to fitting issues and/or require an additional step in assembly to trim excess material. Further, use of a pre-formed single piece rigid substrate which subsequently covered by a flexible material to define the A-side of a door trim panel may require an additional step in manufacturing to trim the excess flexible material along the A-side prior to mounting the door trim panel to a vehicle door. Further, the method disclosed in the '455 patent requires additional assembly steps to include other door panel components prior to mounting the door panel onto a vehicle door.

While vehicle interior trim panels integrating a component of the type known in the related art have generally worked for their intended purposes there remains a need to reduce costs by reducing the number of steps required to manufacture a vehicle interior trim panel assembly incorporating the panel components. In addition, there remains a need for a vehicle interior trim panel having integrated panel components. Finally, there remains a need in the art for a vehicle interior trim panel assembly that provides a quality, desirable, class-A surface that is aesthetically pleasing.

### SUMMARY OF THE INVENTION

The present invention overcomes the disadvantages in the related art in interior trim panels for vehicles and generally fulfills a need in the art for a method of manufacturing an interior trim panel assembly having integrated trim panel components that reduce the cost of manufacture and assembly as well as improves the aesthetic and ergonomic trim component quality. To this end, the method of the present invention includes providing a die including a pair of die halves cooperating to define a mold cavity to form a interior trim panel where at least one of the die halves includes a surface defining an A-surface within the mold cavity and the mold cavity includes a plurality of recesses having a predetermined shape. The method further includes placing at least one trim panel component into the corresponding recess within the mold cavity and closing the die halves. Next, the method includes forming a rigid substrate having an A-side surface visible to the interior of a vehicle when secured to a vehicle door by injecting a molten thermoplastic material having a predetermined pressure less than the maximum clamp pressure of the die into the mold cavity so as to fill the mold cavity. The method of the present invention further includes bonding the molten thermoplastic material to a trim panel component within the mold cavity while the rigid substrate is formed.

Accordingly, one advantage of the present invention is that it provides a vehicle interior trim panel assembly having integrated components that may be manufactured using reduced steps when compared to trim panels known in the related art.

Another advantage of the method of the of the present invention is that it that eliminates quality issues relating to positive alignment during later assembly of the trim panel components to the trim panel per se.

Yet another advantage of the present invention is that it molds a monolithic trim panel while simultaneously bonding the trim panel components thereto in the mold to increase the bond strength between the trim panel and the trim panel components.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is an environmental view of a vehicle including a vehicle interior trim panel assembly having integrated trim panel components in accordance with an embodiment of the present invention;

FIG. 2 is a perspective view of the mold including suspended vehicle interior trim panel components in accordance with the present invention;

FIG. 3 is an in-mold cross-sectional view of a vehicle interior trim panel assembly having integrated trim panel components in accordance with an embodiment of the present invention; and

FIG. 4 is a perspective view of the mold including a suspended vehicle interior trim panel assembly in accordance with an embodiment of the present invention.

### DETAILED DESCRIPTION OF THE INVENTION

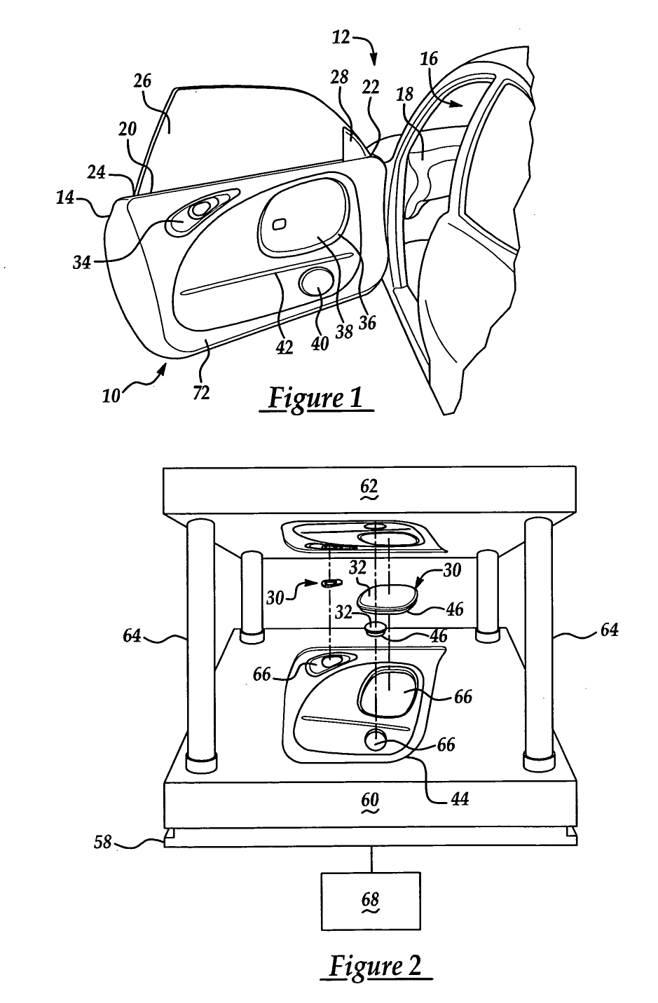

A vehicle interior trim panel assembly having an integrated trim panel component of the present invention is generally indicated at 10 in the figures, where like numbers are used to designate like structure throughout the figures. As shown in FIG. 1, the trim panel assembly 10 is employed within a vehicle, generally indicated at 12. Specifically, the trim panel assembly 10 is shown in mounted to a driver's side door 14 within a vehicle interior 16. However, while the trim panel assembly 10 of the present invention is shown for use in connection with a vehicle door 14, those having ordinary skill in the art will appreciate that it may be employed anywhere within a vehicle interior 16 where a trim panel assembly having an integrated trim panel component is desired. By way of example, the present invention may be a trim assembly for a dashboard 18, a center console (not shown), a glove box (not shown), etc. The vehicle trim panel assembly 10 may also be molded to any predetermined shape to accommodate adjacent components of the vehicle 12. By way of example, the vehicle trim panel assembly 10 shown in FIG. 1 includes predetermined contours 20 and 22 that are adapted to cooperatively engage a window track 24 for receiving a window 26 and a side mirror panel 28 for covering the side mirror mounts (not shown) of a vehicle door 14.

As illustrated in the Figures, the trim panel assembly 10 includes a plurality of trim panel components generally indicated at 30. The trim panel components 30 include at least one surface 32 visible from the vehicle interior 16. Specifically, the trim panel assembly 10 includes a door latch assembly 34 that is adapted to facilitate ingress and egress to and from the vehicle interior 16 and a bolster 36 that is adapted to provide a soft-touch area within the door trim panel assembly 10. The bolster 36 may include a rigid substrate backing and an intermediate foam layer concealed by a flexible coverstock material 38. The coverstock 38 may be constructed from a fabric, leather, a polymer skin formed from polyvinyl chloride (PVC) or thermoplastic olefin (TPO), or other material that provides a soft-touch aesthetic feature visible from the vehicle interior 16. Other trim panel components 30 within the trim panel assembly 10 include a speaker cover 40 to protect the speaker and a map pocket 42 to retain various articles such as maps, compact discs and other articles.

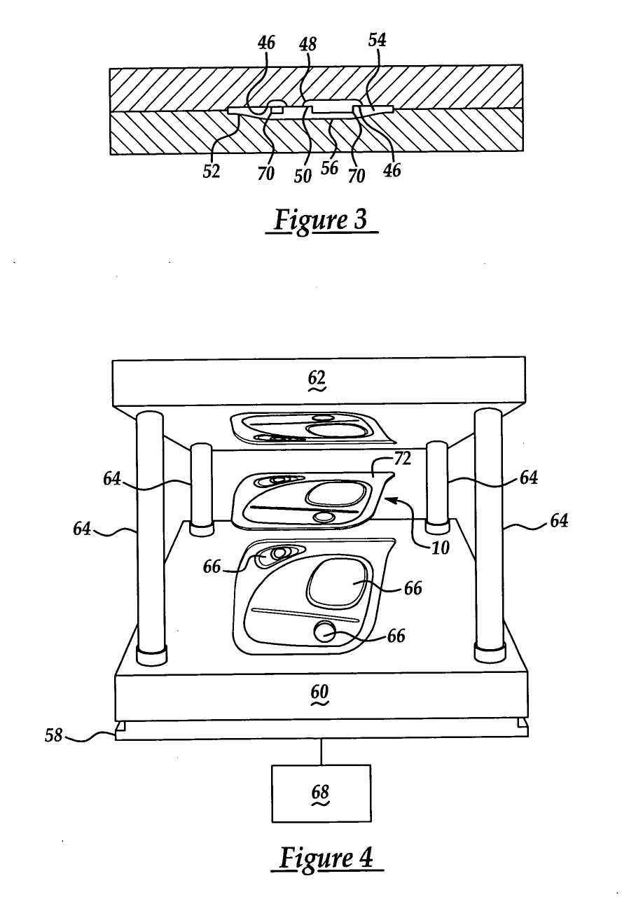

Referring to FIGS. 2-3, the trim panel components 30 are adapted to be placed in a mold cavity 44. Each trim panel component 30 includes a contact surface 46 which may be a lip or plurality of protrusions disposed about the perimeter of the trim panel component 30. In either event, the contact surface 46 facilitates engagement between the trim panel component 30 and the trim panel substrate, to be described in greater detail below. The contact surface 46 may include an A-side 48 that is visible from the vehicle interior 16 when the trim panel assembly 10 is installed onto a vehicle door 14 as well as a B-side 50 located opposite the A-side 48. In the preferred embodiment, the contact surface 46 is constructed from a polymer material. However, those having ordinary skill in the art will appreciate that the contact surface 46 may be constructed from any material and may include several other elements such as barbs or apertures to facilitate engagement between the trim panel component 30 and the trim panel substrate.

As noted above, the trim panel assembly 10 includes a substrate, generally indicated at 52. The substrate 52 includes a first side defining an A-side surface 54 that is visible from the interior 16 of a vehicle 12 when installed to a vehicle door 14 as well as a second side defining a B-side surface 56 that is concealed from the vehicle interior 16. The A-side surface 54 may incorporate a pattern or texture, often simulating the grain of leather imposed thereon by the surface of the mold cavity 44 from which the substrate 52 was formed. The substrate 52 has a predetermined shape and thickness which also corresponds to the form of the mold cavity 44 from which it originated and may be manufactured from several polymer or composite materials commonly known in the art. By way of example, the molded substrate 52 may be manufactured nylon, polypropylene, TPO or PVC or acrylonitrile butadiene styrene (ABS) or other rigid forming polymer.

Referring to FIGS. 2-4, the substrate 52 is injection molded and is the form by which all of the trim panel components 30 are joined to create the trim panel assembly 10 of the present invention. According to the present invention, the trim panel components 30 are joined to the substrate 52 in-situ during the substrate molding process. This method described in greater detail below, reduces the costs associated with manufacturing a trim panel assembly 10 by eliminating the need for secondary handling and subsequent assembly of the trim panel components 30 to the substrate 52 which involves substantial labor efforts and machine time. Specifically, this method of in-situ bonding eliminates the need for heat stacking, sonic welding, or other secondary methods to bond the trim panel components 30 to the trim panel substrate 52.

With continuing reference to FIGS. 2-4, the trim panel components 30 are placed within a mold cavity 44 defined by a mold 58 having two die halves 60, 62 that are supported for movement relative to each other by guide rods 64. Specifically, the trim panel components 30 are placed into recesses 66 within the mold cavity 44 wherein the surface 32 of the trim panel component 30 visible from the vehicle interior 16 corresponds to the A-side surface 54 of the substrate 52 when formed. Molten thermoplastic material is injected into the mold cavity 44 from a source 68 once the mold 58 is closed so as to permit the contact surface 46 of the trim panel component 30 to operatively engage the molten thermoplastic, which substantially surrounds the trim panel components 30. In order to provide a sufficient bond without compromising the integrity of the contact surface 46, the molten thermoplastic is injected at a temperature no greater than the melting point of the contact surface 46.

When left to cool, the molten thermoplastic material forms the trim panel substrate 52 having a terminal edge 70 adjacent the trim panel component 30. Specifically, the A-side 48 of the contact surface 46 may remain visible from the vehicle interior 16 while the B-side 50 of the contact surface 46 is bonded to the trim panel substrate 52. As shown in FIG. (3), the contact surface 46 is bonded to the A-side surface 54 of the trim panel substrate 52. However, those having ordinary skill in the art will appreciate that when bonding the trim panel component 30 to the trim panel substrate 52, the terminal edge 70 of the trim panel substrate 52 may overlap the contact surface 46 of the trim panel component 30. Further, those having ordinary skill in the art will appreciate that the manner by which the each trim panel component 30 bonds to a particular trim panel substrate 52 may not be uniform. Accordingly, some of the trim panel components 30 may bond to a trim panel substrate 52 where the contact surface 46 bonds to the B-side surface 56 of the trim panel substrate 52, while other trim panel components 30 may bond to the trim panel substrate 52 such that the A-side 48 of the contact surface 46 remains visible from the vehicle interior 16. In either event, the bond area between the trim panel component 30 and the trim panel substrate 52 is not visible along the A-side 72 of the trim panel assembly 10, thereby maintaining an aesthetically pleasing A-side 72 trim panel assembly 10.

The present invention provides a vehicle interior trim panel assembly 10 having integrated components 30 bonded to a trim panel substrate 52 while the substrate 52 is formed in a mold 58. Accordingly, the present invention reduces steps in manufacturing, thereby reducing the costs associating with manufacturing a trim panel assembly 10. Further, the in-situ method of manufacturing a trim panel assembly 10 having integrated trim panel components 30 according to the present invention eliminates quality issues relating to positive alignment during later assembly of the trim panel components 30 to the trim panel substrate 52. Still further, the in-situ method of manufacturing a trim panel assembly 10 having integrated trim panel components 30 provides a monolithic trim panel 52 substrate simultaneously bonded to trim panel components 30 to increase the bond strength between the trim panel substrate 52 and the trim panel components 30.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

1. A method of manufacturing a trim panel assembly for the interior of a vehicle having integrated trim panel components, said method comprising the steps of:
providing a die including a pair of die halves cooperating to define a mold cavity to form a interior trim panel, at least one of said die halves including a surface within said mold cavity defining an A-surface, one of said mold cavities including a plurality of recesses having a predetermined shape;
placing at least one trim panel component into said corresponding recess within said mold cavity;
closing said first and said second die halves;
forming a rigid substrate having an A-side surface visible to the interior of a vehicle when secured to a vehicle door in said mold cavity by injecting a molten thermoplastic material having a predetermined pressure less than the maximum clamp pressure of said die into said mold cavity so as to fill said mold cavity; and
bonding said molten thermoplastic material to at least one trim panel component within said mold cavity while said rigid substrate is formed.

2. The method as set forth in claim 1 further including the steps of:
at least partially curing the molten thermoplastic material in said mold cavity to form a finished molded interior trim panel having at least one trim panel component bonded thereto; and
removing the molded interior trim panel assembly having at least one integrated trim panel component from said mold cavity.

3. The method as set forth in claim 1 wherein the step of placing at least one trim panel component into said corresponding recess within said mold cavity further includes providing at least one trim panel component having a contact surface adapted to bond said trim panel component to said molten thermoplastic material rigid substrate forming a rigid substrate.

4. The method as set forth in claim 3 wherein the step of closing said first and said second die halves further includes closing the die so as to permit said contact surface of said trim panel component to operatively engage said molten thermoplastic material.

5. The method as set forth in claim 4 wherein the step of forming a rigid substrate includes injecting a thermoplastic material at a temperature no greater than the melting point of said contact surface.

6. The method as set forth in claim 1 wherein the step of placing at least one trim panel component into said corresponding recess within said mold cavity further includes placing a trim panel component having at least one surface visible to a vehicle interior into said corresponding recess within said mold cavity and matching said visible surface of said trim panel component to the A-surface of said mold cavity.

7. The method as set forth in claim 1 wherein the step of bonding said molten thermoplastic material to at least one trim panel component within said mold cavity further includes bonding said thermoplastic material to said trim panel component where the bond line is not visible along the A-surface of said formed rigid substrate.

8. The method as set forth in claim 1 wherein the step of bonding said molten thermoplastic material to at least one trim panel component within said mold cavity further includes bonding said thermoplastic material to said trim panel component where the visible surface of said trim panel component and the A-side surface formed by said thermoplastic material bond along a substantially similar plane to provide a compact bond line reveal.

9. A trim panel assembly for the interior of a vehicle having integrated trim panel components comprising:
at least one trim panel component adapted for placement in a mold cavity, said trim panel component adapted for use vehicle trim panel applications having at least one surface visible from a vehicle interior;
a substrate adapted for use as a vehicle interior door trim panel formed from injection of a rigid forming polymer into a mold wherein said formed substrate operatively engages said trim panel component,
said substrate having a first side and a second side opposite said first side, said first side defining a A-side surface exposed to the vehicle interior when secured to a vehicle door, said second side defining a B-side surface concealed from the vehicle interior when secured to a vehicle door.

10. The trim panel assembly as set forth in claim 9 wherein said trim panel component and said substrate are operatively engaged such that said visible surface of said trim panel component and said A-side surface of said substrate are visible when secured to a vehicle door.

11. The trim panel assembly as set forth in claim 9 wherein said trim panel component includes at least one contact surface operatively engaged to said substrate and said substrate includes a terminal edge adjacent said trim panel component.

12. The trim panel assembly as set forth in claim 11 wherein said contact surface bonded to said B-side surface of said substrate adjacent said terminal edge, said contact surface substantially concealed from the vehicle interior when secured to a vehicle door.

13. The trim panel assembly as set forth in claim 11 wherein said contact surface having a first side defining an A-side and a second side defining a B-side opposite said first side, said B-side bonded to said substrate adjacent said terminal edge, said A-side exposed to the vehicle interior when secured to a vehicle door.

14. The trim panel assembly as set forth in claim 11 wherein said contact surface is a lip disposed about the perimeter of said trim panel component adapted to bond said trim panel component to said substrate while formed.

15. The trim panel assembly as set forth in claim 11 wherein said contact surface is a plurality of protrusions adapted to bond said trim panel to said substrate while formed.

16. The trim panel assembly as set forth in claim 9 wherein said trim panel component is a bolster adapted to provide a soft-touch, cushion-like feature.

17. The trim panel assembly as set fort in claim 9 wherein said trim panel component is a map pocket adapted to a retain articles therein.

18. The trim panel assembly as set fort in claim 9 wherein said trim panel component is a speaker cover.

19. The trim panel assembly as set fort in claim 9 wherein said trim panel component is a door latch assembly adapted to facilitate ingress and egress to the vehicle interior.
